(19) United States
(12) Patent Application Publication
(10) Pub. No.: US 2008/0254420 A1
(43) Pub. Date: Oct. 16, 2008

(54) INTEGRATION OF PURSUIT OF GOALS WITH PHYSICAL ACTIVITY

(76) Inventor: Arnold Nerenberg, Whittier, CA (US)

Correspondence Address: SCHMEISER, OLSEN & WATTS, 22 CENTURY HILL DRIVE, SUITE 302, LATHAM, NY, 12110, US

(21) Appl. No.: 11/733,255

(22) Filed: Apr. 10, 2007

(51) Int. Cl. G09B 19/00

(52) U.S. Cl. 434/236

(57) ABSTRACT

A method. A first person is instructed by a second person to execute an activity. The activity includes performance of at least one physical exercise and recitation of words during performance of the at least one physical exercise. The recited words relate to at least one goal of the first person. The at least one goal is unrelated to and not a consequence of the at least one physical exercise.

### FIELD OF THE INVENTION

The present invention relates to method for integrating pursuit of goals with physical activity.

### BACKGROUND OF THE INVENTION

Attempting to achieve internal and/or external goals typically lack sufficient support to enable the goals to be achieved. Thus a method is needed to provide sufficient support to enable a person to achieve goals that the person is attempting to achieve.

### SUMMARY OF THE INVENTION

The present invention provides a method, comprising instructing a first person to execute an activity, wherein executing the activity comprises performing at least one physical exercise and reciting words during said performing the at least one physical exercise, wherein the recited words relate to at least one goal of the first person, wherein the at least one goal is unrelated to and not a consequence of the at least one physical exercise, and wherein said instructing the first person is performed by a second person.

The present invention provides a method, comprising receiving, by a first person from a second person, instruction to execute an activity, wherein executing the activity comprises performing at least one physical exercise and reciting words during said performing the at least one physical exercise, wherein the recited words relate to at least one goal of the first person, and wherein the at least one goal is unrelated to and not a consequence of the at least one physical exercise.

The present invention advantageously provides sufficient support to enable a person to achieve goals that the person is attempting to achieve.

### BRIEF DESCRIPTION OF THE DRAWINGS

FIG. 1 depicts a second person instructing a first person to execute an activity, in accordance with embodiments of the present invention.

FIG. 2 depicts the second person of FIG. 1 instructing a plurality of persons to execute an activity, in accordance with embodiments of the present invention.

FIG. 3 is a flow chart describing a method performed by the second person who instructs the first person of FIG. 1 to execute an activity, in accordance with embodiments of the present invention.

FIG. 4 is a flow chart describing a method performed by the second person who instructs the plurality of persons of FIG. 2 to execute an activity, in accordance with embodiments of the present invention.

### DETAILED DESCRIPTION OF THE INVENTION

### Introduction

The present invention integrates pursuit of goals with physical activity, which transfers psychotherapy and counseling from the office of a therapist, coach, teacher, etc. to an exercise environment such as a gymnasium (“gym”), office, etc. A therapist may be, inter alia, a psychologist, psychiatrist, clinical social worker, etc.)

An office might be viewed by a client or patient as a formal environment that is uncomfortable and/or threatening. In contrast, a gym may provide a less intimidating environment for many clients and patients. The gym represents health, strength, and potential for a thin and attractive physique. In effect, what the therapist, coach, teacher, etc. can do for clients and patients in the office can likewise be done in a gym in some embodiments of the present invention. In one embodiment, however, physical exercises may be performed according to the present invention in the office of the therapist, coach, teacher, etc., such as through use of exercises equipment located in the therapist's office.

Thus, the present invention combines physical exercise with words that the client/patient recites while performing the physical exercise. The words may be recited before, during, and/or after performance of each repetition of one or more repetitions within one or more sets of the physical exercise. The recited words relate to at least one goal of the client/patient, wherein the at least one goal is unrelated to and not a consequence of the physical exercise. The recited words may be “power thoughts”. The power thoughts are the recited words memorized by the client/patient prior to or during performance of the physical exercise (e.g., as directed or modified by a therapist, coach, teacher, etc. during performance of the physical exercise). Thus, the power thought facilitates accomplishment of the at least one goal.

### Power Thoughts

Examples of power thoughts compatible with the present invention comprise: “I will have compassion for those who offend me”; “I am becoming healthier and stronger”; “I will put my wife's needs before my own”; “I can do it and I am grateful”.

A power thought empowers the client/patient to think the way the client/patient chooses to think and provides a basis for the client/patient to control his or her thoughts, feelings, and/or actions and/or combinations thereof to improve performance in all areas of life, such as by staying focused on positive goals, thoughts, and/or feelings, and by removing deterrents to effectiveness.

The power thought is a thought that could beneficially be called into action (e.g., by repetitive recital thereof) on a regular basis. For example in one embodiment, by repetition of a power thought in time (e.g., every five minutes the first day and twice per hour thereafter for a specified period of time), the client/patient may experience beneficial results, such as reduced stress from all areas of life (e.g., anger, jealousy, finances, hatred, etc.) and a strengthening of the client/patient's physical, mental, and spiritual well-being. Repeating the power thought every five minutes and then twice per hour puts the client/patient in a state of readiness and preparedness.

A power thought is more than positive thinking and is aimed at target areas such as strength, anger, jealousy, negative expectations, substance abuse, health issues, etc. The power thought is not an attempt to deny negativity, but can actually prevent negative thoughts and negative events from starting, or reduce their impact if they do arise.

Power thoughts can be strengthened through use of amplifiers, solidifiers, shield penetrators, focusers, expanders, directors, and other strengthening means.

An “amplifier” increases the intensity of the power thought. For example, the power thought “I will be good to you” becomes “I will be very good to you.” The word “very” is the amplifier. The power thought “I will put her needs before mine” becomes “I will put her needs before mine, always.” The word “always” is the amplifier. “I will do it.” becomes “I will do it, really.” The word “really” is the amplifier. “I will be more than fine.” The words “more than” are the amplifier. In each case the amplifier increases the power, intensity, and dominion of the power thought. Physical exercise (e.g., lifting light, moderate, heavy weights) is also an amplifier and serves as a basis for the present invention. The physical exercise commits the person engaged in the physical exercise to the power thought and facilitates the person to more fully internalize the power thought.

A “solidifier” states a belief or faith that the power thought will manifest in external reality. For example, “justice will prevail.” becomes, “justice will prevail, and I'm grateful for that.” The phrase “I'm grateful for that” is the solidifier implying that “justice will prevail.” in external reality; i.e., justice will not simply remain in the realm of words or hope. “I will be fine, really” becomes “I will be fine, really; and I'm grateful for that.” Again “I'm grateful for that.” is the solidifier. Note, the statement is not “I will be grateful for that”, but rather is stated in the present tense, “I am grateful for that.” This means being grateful now for belief, knowledge, and faith in what will be in the future. Gratitude is a powerful solidifier, which adds health to the body and mind. “I forgive you for hurting me. So it is said, and so it is” comprises the power thought “I forgive you for hurting me” which is solidified by the statement “So it is said, and so it is.” It should be noted that a solidifier can be amplified. With “Justice will prevail, and I'm very grateful for that”, the word “very” amplifies the solidifier “I'm grateful for that.”

With respect to shield penetrators, if a person has doubt that the person can do something, then to simply affirm that the person can do it may make the doubt stronger. For example, a man may doubt that he can lift 400 pounds, or the man might even believe that he cannot lift 400 pounds. For the man to say, “I can do it.” can just make the opposite thought stronger: “I cannot do it.” There is a “shield” around the thought; the shield is the thought “I cannot do it”. To say “I can do it” does not penetrate the shield; the feeling remains, “I cannot do it.” Thus, consider the following power thought: “Even though I doubt I can do it, I will -in fact- do it.” The statement, “Even though I doubt I can do it”, penetrates the shield of doubt or disbelief. Thus, the man can become empowered to feel the reality “I will -in fact- do it.” The words “in fact” are a solidifier.

A “focuser” is a procedure or instruction which facilitates focusing on the spoken power thought. For example, focusing attention on the power thought being spoken leads to greater remembering and internalizing. By repeating the power thought, there is both an amplification effect and a focusing effect; up to a point, the louder the power thought is verbalized the more is the amplification. Music can have both effects (i.e., amplification and focusing) as can taking a deep breath.

An extremely powerful amplifier and focuser is physical exercise, such as light to moderate weight lifting. For example, during the bench-press, as the person lowers the bar the person might say, “I can.” Then as the person raises the bar off his chest the person says, “I will.” The physiological effects of increased blood flow and muscle contraction have an amplifier effect and focusing effect. The thought is integrated into the neuro-muscular action itself. Lifting heavy weights is less likely to have these benefits because the weight becomes the focus instead of the thought.

An “expander” increases the breadth of positivity. An example of an expander is: “I will be fine” and “And I have a wonderful future.” The whole power thought is: “I will be fine. I am very grateful. And I have a wonderful future.”

Looking at a watch can be a “reminder” to say the power thought. If power thoughts are repeated while working out, then working out can be a reminder.

A “director” is a thought or statement that directs attention to a given thought. For example: “I will repeat my power thought every five minutes” is statement which is a director. “I will search right now for a constructive thought” is another example.

### Implementation of the Present Invention

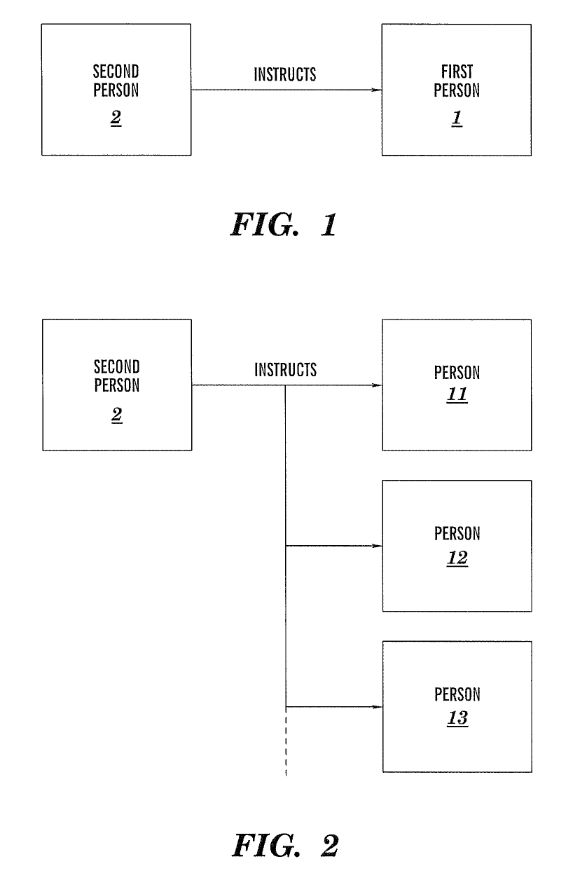

FIG. 1 depicts a second person 2 instructing a first person 1 to execute an activity, in accordance with embodiments of the present invention. Executing the activity comprises performing at least one physical exercise and reciting words during said performing the at least one physical exercise. The recited words relate to at least one goal of the first person 1 and may comprise one or more power thoughts.

In one embodiment, instructing the first person 1 may constitute a unidirectional communication of words from the second person 2 to the first person 1, such that the first person accepts, and recites the words of, the unidirectional communication without providing interactive feedback to the second person 2. For example, the second person 2 may instruct the first person 1 to recite the words “I can do it”, and the first person 1 then proceeds to recite the words “I can do it” while performing the at least one physical exercise.

In one embodiment, instructing the first person 1 may constitute interactive feedback communication between the second person 2 and the first person 1. For example, instructing the first person 1 may comprise the following sequence. First the second person 2 instructs the first person 1 to recite the words “I can do it” while performing the at least one physical exercise. Second, the first person 1 then says to the second person 2: “I think that the words ‘God, please help me to do it’ would be more effective.” Third, the second person 2 then says to the first person 1: “OK, recite ‘God, please help me to do it’. Fourth, the first person 1 then proceeds to recite the words “God, please help me to do it” while performing the at least one physical exercise.

The at least one goal is unrelated to and not a consequence of the at least one physical exercise. For example if the at least one physical exercise comprises a lifting of weights, then the at least one goal would not include the goal of developing a more muscular body, because developing a more muscular body is related to and/or a consequence of the lifting of weights. As another example, if the at least one physical exercise comprises running, then at least one goal would not include the goal of losing weight, because losing weight is related to and/or a consequence of the running.

The first person 1 may be a male or female of any age and condition (i.e., physical and mental condition) such that the first person 1 is capable of receiving an instruction from the second person 2 and of executing the activity relating to the instruction. The first person 1 may be at least one of a client, patient, and student of the second person 2 with respect to at least one issue that the first person 1 has been attempting to resolve with assistance from the second person 2 acting as at least one of a therapist, coach, and teacher of the first person 1. The at least one goal of the recited words relates to the at least one issue. The at least one issue may comprise any issue that the first person 1 is attempting to resolve (e.g., inability to control anger, inability to communicate effectively with the first person's children and/or parents, inability to express emotion constructively, lack of self confidence, excessive anxiety, memory problems, inability to finish a project, poor study habits, sexual dysfunction, drug addiction, etc.).

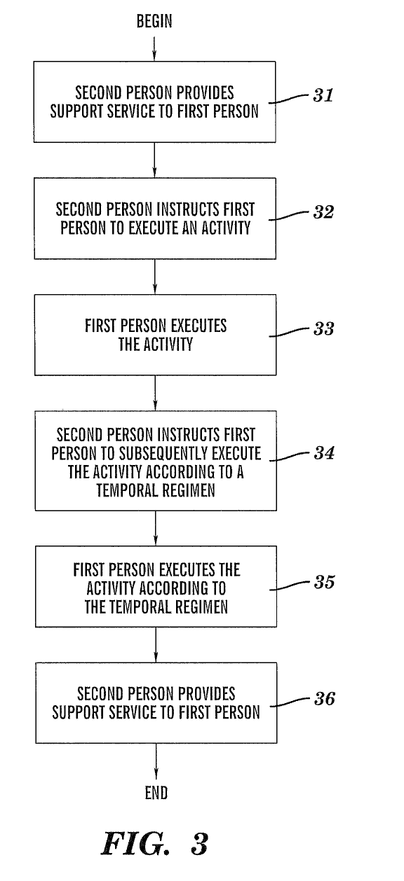

FIG. 3 is a flow chart describing a method performed by the second person 2 who instructs the first person 1 (see FIG. 1) to execute an activity, in accordance with embodiments of the present invention. The method of FIG. 3 comprises steps 31-36.

In step 31, the second person 2 provides a support service to the first person 1. The support service provided by the second person 2 to the first person 1 may comprise at least one of psychotherapy, medical service (e.g., medical treatment/healing service), counseling, coaching, personal training, and teaching with respect to the at least one issue.

In step 32, the second person 2 instructs the first person 1 to execute an activity. In step 33, the first person 1 executes the activity, in response to having been instructed to do in step 32.

Executing the activity may comprise performing at least one physical exercise and reciting words, ranging in volume to subvocal to screaming during said performing the at least one physical exercise. The recited words relate to at least one goal of the first person 1, wherein the at least one goal is unrelated to and not a consequence of the at least one physical exercise.

Said instructing the first person 1 may comprise performing said activity by the second person 2 to demonstrate to the first person 1 how to perform the activity.

Said instructing the first person 1 may comprise instructing the first person 1 to recite the words with strong emotion at about a highest volume level that the first person 1 is capable of, or both with said strong emotion and at about said highest volume level.

Said instructing the first person 1 may comprise instructing the first person 1 to recite the words at very low (i.e., barely audible) volume.

The at least one physical exercise may comprise a plurality of physical exercises. The at least one goal may comprise a plurality of goals. The at least one goal may relate to resolving one or more issues of the at least one issue that the first person 1 has been attempting to resolve with assistance from the second person 2.

Each physical exercise of the at least one physical exercise may comprise an isotonic exercise (e.g., a weight bearing or lifting exercise), an isometric exercise, an aerobic exercise, a stretching exercise, etc.

An isotonic exercise involves muscular contraction in which a muscle is under constant tension while its length changes either by being shortened or by being lengthened. An example of an isotonic exercise is an exercise in which a weight or resistance is raised or lowered (e.g., repetitively raised or lowered). Some isotonic exercises use free weights, while other isotonic exercises use machine weights.

An isometric exercise involves muscular contraction against a resistance in which the length of the muscle does not change while the exercise is being performed. An example of an isometric exercise is pushing against a stationary wall.

An aerobic exercise conditions the heart and lungs by increasing the oxygen available to the body and by enabling the heart to use oxygen more efficiently. Examples of aerobic exercise include running, swimming, and cycling.

A stretch exercise elongates a muscle by moving its two ends away from one another. Stretching is recommended by doctors, therapists, and trainers to prevent muscular injury Reciting the words (as instructed to do so in step 32 and as executed in step 33) may comprise repetitively reciting the words when performing the at least one physical exercise. In one embodiment, the at least one physical exercise comprises a rhythmic pattern, wherein said repetitively reciting the words comprises repetitively reciting the words synchronously with respect to the rhythmic pattern when performing the at least one physical exercise.

For example, consider a scenario in which the first person 1 is receiving counseling from the second person 2 who is a psychologist with respect to the issue of the first person 1 being able to be control the first person's anger (step 31); i.e., the first person 1 is overly susceptible to becoming angry. In step 32, the psychologist instructs the first person 1 to perform a specified number (e.g., two) sets of bench pressing of an appropriate amount of weight, wherein in each cycle of each set the first person 1 recites “I will control my anger”. The cycles of each set collectively define the rhythmic pattern of the bench pressing exercise. Bench pressing is performed by a person while down such that the back of the person is in contact with a flat horizontal surface such as a bench. Each bench pressing cycle comprises a lifting phase (in which the weight is lifted) and a subsequent lowering phase (in which the lifted weight is lowered). In this example, the first person 1 recites “I will control my anger” in either the lifting phase or the lowering phase (but not both), which is in accordance with reciting the words synchronously with respect to the rhythmic pattern when performing the bench pressing exercise.

In one embodiment, the rhythmic pattern comprises a plurality of cycles of physical activity within a first physical exercise of at least one physical exercise, wherein each cycle comprises a plurality of phases, wherein said words comprise a plurality of verbal segments, and wherein said repetitively reciting the words comprises repetitively reciting each verbal segment of the plurality of verbal segments during a different phase of the plurality of phases in each cycle of the plurality of cycles.

For example, consider a scenario in which the first person 1 is receiving counseling from the second person 2 who is a psychologist with respect to the issue of the first person 1 being able to be control the first person's anger (step 31); i.e., the first person 1 is overly susceptible to becoming angry. In step 32, the psychologist instructs the first person 1 to perform a specified number (e.g., two) of sets of bench pressing of an appropriate amount of weight, wherein in each cycle of each set the first person 1 recites “I will control my anger because I am cool”. The phrase “I will control my anger” is a first verbal segment of the recited words, and the phrase “because I am cool” is a second verbal segment of the recited words. The instruction by the second person specifies that the first verbal segment (“I will control my anger”) is to be recited by the first person 1 during the lifting phase of the bench pressing exercise, and the second verbal segment (“because I am cool”) is to be recited by the first person 1 during the lowering phase of the bench pressing exercise. Thus, each verbal segment is recited during a different phase in each cycle of the bench pressing exercise. In one embodiment, person 2 may or may not repeat reciting the power thought along with 1. Also, person 2 may demonstrate the process to person 1 by repeating reciting the power thought while person 2 is doing the bench press and/or while person 1 is doing the bench press.

The at least one physical exercise may comprise reciting a plurality of power thoughts while performing at least one physical exercise. For example, consider a scenario in which the second person 2 instructs the first person 1 to recite two power thoughts while performing at least one physical exercise. The two power thoughts are: “I can do it and I am grateful” (Power Thought 1) and “I will put my wife's need before my own” (Power Thought 2). In a first embodiment, the two power thought can be performed in alternating cycles of a bench pressing exercise. In a second embodiment, the two power thought can be performed in two different exercises in a one-to-one correspondence between the two power thoughts and the two exercises.

For example, in the first embodiment wherein the two power thoughts are performed in alternating cycles of a same exercise (i.e., bench pressing in the example), Power Thought 1 ( “I can do it and I am grateful”) and Power Thought 2 (“I will put my wife's need before my own”) are performed as depicted in Table 1.

TABLE 1

| Cycle | Phase | Power Thoughts | Verbal Segment |
|---|---|---|---|
| 1 | Lifting | 1 | I can do it |
| 1 | Lowering | 1 | and I am grateful |
| 2 | Lifting | 2 | I will put my wife's needs |
| 2 | Lowering | 2 | before my own |
| 3 | Lifting | 1 | I can do it |
| 3 | Lowering | 1 | and I am grateful |
| 4 | Lifting | 2 | I will put my wife's needs |
| 4 | Lowering | 2 | before my own |
| 5, etc. | | | |

For example, in the second embodiment such that the two power thoughts are performed in two different exercises in a one-to-one correspondence between the two power thoughts and the two exercises, Power Thought 1 ( “I can do it and I am grateful”) and Power Thought 2 (“I will put my wife's need before my own”) are performed as follows. The two exercises are denoted as Exercise 1 (e.g., bench pressing) and Exercise 2 (e.g., lifting dumbbells). Power Thought 1 is performed solely in Exercise 1 and Power Thought 2 is performed solely in Exercise 2.

In accordance with the preceding second embodiment, the at least one physical exercise comprises a plurality of physical exercises, wherein said executing the activity in step 33 comprises reciting the words pertaining to each goal of the plurality of goals when performing a corresponding different physical exercise of the plurality of physical exercises.

In step 33, the second person 2 may execute the activity concurrent with execution of the activity by the first person 1 for any of various reasons such as to enhance motivation by the first person 1 to recite the words with sufficient conviction. In one embodiment, the concurrent execution of the activity by the second person 2 may comprise performing the at least one physical exercise by the second person at a same physical tension level (e.g., same magnitude of weight lifted) as is performed by the first person 1 during said execution of the activity by the first person 1. In one embodiment, the concurrent execution of the activity by the second person 2 may comprise performing the at least one physical exercise by the second person at a different physical tension level than is performed by the first person 1 during said execution of the activity by the first person 1.

The first person 1 executes the activity in step 33 in any suitable exercise-supporting environment such as, inter alia, a gymnasium, an exercise room, any room of a building such that said any room comprises exercise equipment, on a running track, in a swimming pool, etc.

In step 34, the second person directs the first person 1 to subsequently execute the activity according to a specified temporal regimen over a period of time comprising a plurality of days. For example, the specified temporal regimen may be to execute the activity twice per day during the first week and once per day thereafter. As another example, the specified temporal regimen may comprise reciting words immediately before or immediately after performance of each exercise.

In one embodiment, the specified temporal regimen requires that the first person 1 execute the activity for a specific length of time at least once per day during every day of the period of time.

In one embodiment, the period of time is a specified fixed period of time (e.g., one week, one month, one year, etc.).

In one embodiment, the period of time is a variable period of time that ends upon satisfaction of a specified condition. For example, the period of time may end when the at least one goal has been substantially accomplished (e.g., as determined by the first person 1). As another example assuming that the at least one goal comprises expressing more love and affection by the first person 1 to the first person's spouse, the period of time may end when the first person 1 becomes divorced from the first person's spouse. As yet another example, the period of time may end when the first person 1 dies (i.e., the first person 1 executes the activity according to the specified temporal regimen for the remainder of the first person's life).

In step 35, the first person 1 executes the activity according to the temporal regimen over the period of time.

In step 36, the second person 2 provides a support service to the first person 1. Similar to step 31, the support service provided by the second person 2 to the first person 1 may comprise at least one of psychotherapy, counseling, coaching, and teaching with respect to the at least one issue. Steps 31 and 36 are distinguished as follows. In step 31 the support service is provided to the first person 1 by the second person 2 before the second person 2 instructs the first person 1 in step 32, whereas in step 36 the support service is provided to the first person 1 the second person 2 after the second person 2 instructs the first person 1 in step 32 and after the first person executes the activity in step 33.

FIG. 2 depicts the second person 2 of FIG. 1 instructing a plurality of persons 11, 12, 13, . . . to execute an activity, in accordance with embodiments of the present invention. Hereinafter, the phrase “plurality of persons” means the plurality of persons 11, 12, 13, . . . in FIG. 2.

In one embodiment, said instructing the plurality of persons comprises simultaneously instructing the plurality of persons. In one embodiment, said instructing the plurality of persons doe not comprise simultaneously instructing the plurality of persons.

Executing the activity comprises performing at least one physical exercise and reciting words during said performing the at least one physical exercise. The recited words relate to at least one goal of each person of the plurality of persons.

In one embodiment, instructing the plurality of persons may constitute a unidirectional communication of words from the second person 2 to the plurality of persons, such that the plurality of persons accepts, and recites the words of, the unidirectional communication without providing interactive feedback to the second person 2. For example, the second person 2 may instruct the plurality of persons to recite the words “I can do it” “while performing the at least one physical exercise, and the plurality of persons then proceeds to recite the words “I can do it” while performing the at least one physical exercise.

In one embodiment, instructing the plurality of persons may constitute interactive feedback communication between the second person 2 and the plurality of persons. For example, instructing the plurality of persons may comprise the following sequence. First the second person 2 instructs the plurality of persons to recite the words “I can do it” while performing the at least one physical exercise. Second, a person of the plurality of persons then says to the second person 2: “I think that the words ‘God, please help me to do it’ would be more effective.” Third, the second person 2 then says to the plurality of persons: “What do you think about reciting ‘God, please help me to do it?’”. Fourth, a majority of persons of the plurality of persons express to the second person 2 approval of the words “God, please help me to do it”. Fifth, the second person 2 then says to the plurality of persons: “OK, recite ‘God, please help me to do it’.” Sixth, the plurality of persons then proceeds to recite the words “God, please help me to do it” while performing the at least one physical exercise.

The at least one goal is unrelated to and not a consequence of the at least one physical exercise. For example if the at least one physical exercise comprises a lifting of weights, then at least one goal would not include the goal of developing a more muscular body, because developing a more muscular body is related to and/or a consequence of the lifting of weights. As another example, if the at least one physical exercise comprises running, then at least one goal would not include the goal of losing weight, because developing a more muscular body is related to and/or a consequence of the running.

Each person of the plurality of persons may independently be a male or female of any age and condition (i.e., physical and mental condition) such that each person of the plurality of persons is capable of receiving an instruction from the second person 2 and of executing the activity relating to the instruction. Each person of the plurality of persons may be at least one of a client, patient, and student of the second person 2 with respect to at least one issue that said any person has been attempting to resolve with assistance from the second person 2 acting as at least one of a therapist, coach, and teacher of said each person. The at least one goal of the recited words relates to the at least one issue. The at least one issue may comprise any issue that each person is attempting to resolve (e.g., inability to control anger, inability to communicate effectively with said at least one person's children and/or parents, inability to express emotion constructively, lack of self confidence, excessive anxiety, memory problems, inability to finish a project, poor study habits, sexual dysfunction, drug addiction, etc.).

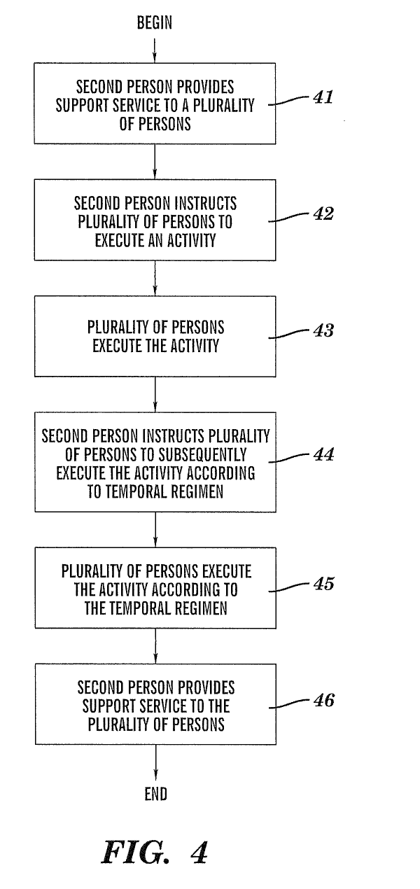

FIG. 4 is a flow chart describing a method performed by the second person 2 who instructs the plurality of persons of FIG. 2 to execute an activity, in accordance with embodiments of the present invention.

The method of FIG. 4 comprises steps 41-46.

In step 41, the second person 2 provides a support service to the plurality of persons. The support service provided by the second person 2 to the plurality of persons may comprise at least one of psychotherapy, counseling, coaching, and teaching with respect to the at least one issue.

In step 42, the second person 2 instructs each person of the plurality of persons to execute an activity. In step 43, said each person executes the activity, in response to having been instructed to do so in step 42.

Executing the activity comprises performing at least one physical exercise and reciting words during said performing the at least one physical exercise. The recited words relate to at least one goal of each person of the plurality of persons, wherein the at least one goal is unrelated to and not a consequence of the at least one physical exercise.

The plurality of persons may comprise the first person 1 of FIG. 1.

In one embodiment, the plurality of persons consists of a family, wherein the family consists of the first person 1 and at least one family member of the first person 1, and wherein the at least one goal of each person of the family comprises a same goal. In one embodiment, each person of the family is at least one of a client, patient, and student of the second person with respect to at least one same issue that each person of the family has been attempting to resolve with assistance from the second person acting as at least one of a therapist, coach, and teacher of each person of the family. In one embodiment, the family comprises spouses married to each other, wherein one of said spouses is the first person 1. In one embodiment, the family comprises a parent and a child of the parent, and wherein either the parent or the child is the first person 1.

In one embodiment, the plurality of persons consists of an audience of persons, and wherein said instructing is performed to said audience of persons by the second person 2 functioning as at least one of a teacher and a coach of said audience of persons.

Said instructing the plurality of persons may comprise performing said activity by the second person 2 to demonstrate to the plurality of persons how to perform the activity.

Said instructing the plurality of persons may comprise instructing the plurality of persons to recite the words with strong emotion at about a highest volume level that the plurality of persons is capable of, or both with said strong emotion and at about said highest volume level.

Said instructing the plurality of persons may comprise instructing the plurality of persons to recite the words at very low (i.e., barely audible) volume.

The at least one physical exercise may comprise a plurality of physical exercises. The at least one goal of each person may comprise a plurality of goals. The at least one goal may relate to resolving one or more issues of the at least one issue that the plurality of persons has been attempting to resolve with assistance from the second person 2.

Each physical exercise of the at least one physical exercise may comprise an isotonic exercise (e.g., a weight bearing or lifting exercise), an isometric exercise, an aerobic exercise, a stretching exercise, etc., as defined and explained supra.

Reciting the words (as instructed to do so in step 42 and as executed in step 43) may comprise repetitively reciting the words when performing the at least one physical exercise. In one embodiment, the at least one physical exercise comprises a rhythmic pattern, wherein said repetitively reciting the words comprises repetitively reciting the words synchronously with respect to the rhythmic pattern when performing the at least one physical exercise.

For example, consider a scenario in which the plurality of persons are receiving counseling from the second person 2 who is a psychologist with respect to the issue of being able to communicate effectively (step 41). In step 42, the psychologist instructs the plurality of persons to perform a specified number (e.g., two) sets of bench pressing of an appropriate amount of weight, wherein in each cycle of each set the plurality of persons recites “I will communicate effectively”. The cycles of each set collectively define the rhythmic pattern of the bench pressing exercise. Bench pressing is performed by a person while down such that the back of the person is in contact with a flat horizontal surface such as a bench. Each bench pressing cycle comprises a lifting phase (in which the weight is lifted) and a subsequent lowering phase (in which the lifted weight is lowered). In this example, the plurality of persons recites “I will communicate effectively” in either the lifting phase or the lowering phase (bot not both), which is in accordance with reciting the words synchronously with respect to the rhythmic pattern when performing the bench pressing exercise.

In one embodiment as explained with accompanying examples supra in conjunction with steps 32-33 of FIG. 3, the rhythmic pattern comprises a plurality of cycles of physical activity within a first physical exercise of at least one physical exercise, wherein each cycle comprises a plurality of phases, wherein said words comprise a plurality of verbal segments, and wherein said repetitively reciting the words comprises repetitively reciting each verbal segment of the plurality of verbal segments during a different phase of the plurality of phases in each cycle of the plurality of cycles.

In one embodiment as explained with accompanying examples supra in conjunction with steps 32-33 of FIG. 3, the at least one physical exercise may comprise reciting a plurality of power thoughts while performing at least one physical exercise.

In step 43, the second person 2 may execute the activity concurrent with execution of the activity by the plurality of persons for any of various reasons such as to enhance motivation by the plurality of persons to recite the words with sufficient conviction. In one embodiment, the concurrent execution of the activity by the second person 2 may comprise performing the at least one physical exercise by the second person at a same physical tension level (e.g., same magnitude of weight lifted) as is performed by the plurality of persons during said execution of the activity by the plurality of persons. In one embodiment, the concurrent execution of the activity by the second person 2 may comprise performing the at least one physical exercise by the second person at a different physical tension level than is performed by the plurality of persons during said execution of the activity by the plurality of persons.

The plurality of persons executes the activity in step 43 in any suitable exercise-supporting environment such as, inter alia, a gymnasium, an exercise room, any room of a building such that said any room comprises exercise equipment, on a running track, in a swimming pool, etc.

In step 44, the second person directs the plurality of persons to subsequently execute the activity according to a specified temporal regimen over a period of time comprising a plurality of days. For example, the specified temporal regimen may be to execute the activity twice per day during the first week and once per day thereafter. As another example, the specified temporal regimen may comprise reciting words immediately before or immediately after performance of each exercise.

In one embodiment, the specified temporal regimen requires that the plurality of persons execute the activity at least one per day during every day of the period of time.

In one embodiment, the period of time is a specified fixed period of time (e.g., one week, one month, one year, etc.).

In one embodiment, the period of time is a variable period of time that ends upon satisfaction of a specified condition, as explained with accompanying examples supra in conjunction with steps 32-33 of FIG. 3.

In step 45, the plurality of persons executes the activity according to the temporal regimen over the period of time.

In step 46, the second person 2 provides a support service to the plurality of persons. Similar to step 41, the support service provided by the second person 2 to the plurality of persons may comprise at least one of psychotherapy, counseling, coaching, and teaching with respect to the at least one issue. Steps 41 and 46 are distinguished as follows. In step 41 the support service is provided to the plurality of persons by the second person 2 before the second person 2 instructs the plurality of persons in step 42, whereas in step 46 the support service is provided to the plurality of persons the second person 2 after the second person 2 instructs the plurality of persons in step 42 and after the plurality of persons execute the activity in step 33.

While particular embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method, comprising instructing a first person to execute an activity, wherein executing the activity comprises performing at least one physical exercise and reciting words during said performing the at least one physical exercise, wherein the recited words relate to at least one goal of the first person, wherein the at least one goal is unrelated to and not a consequence of the at least one physical exercise, and wherein said instructing the first person is performed by a second person.

2. The method of claim 1, wherein said reciting the words comprises repetitively reciting the words when performing the at least one physical exercise.

3. The method of claim 2, wherein the at least one physical exercise comprises a rhythmic pattern, and wherein said repetitively reciting the words comprises repetitively reciting the words synchronously with respect to the rhythmic pattern when performing the at least one physical exercise.

4. The method of claim 3, wherein the rhythmic pattern comprises a plurality of cycles of physical activity within a first physical exercise of at least one physical exercise, wherein each cycle comprises a plurality of phases, wherein said words comprise a plurality of verbal segments, and wherein said repetitively reciting the words comprises repetitively reciting each verbal segment of the plurality of verbal segments during a different phase of the plurality of phases in each cycle of the plurality of cycles.

5. The method of claim 1, wherein the at least one physical exercise comprises a plurality of physical exercises.

6. The method of claim 1, wherein the at least one goal comprises a plurality of goals.

7. The method of claim 6, wherein the at least one physical exercise comprises a plurality of physical exercises, and wherein said executing comprises reciting the words pertaining to each goal of the plurality of goals when performing a corresponding different physical exercise of the plurality of physical exercises.

8. The method of claim 1, wherein the first person is at least one of a client, patient, and student of the second person with respect to at least one issue that the first person has been attempting to resolve with assistance from the second person acting as at least one of a therapist, coach, and teacher of the first person.

9. The method of claim 8, wherein the method further comprises:
prior to said instructing, providing by the second person at least one of psychotherapy, counseling, coaching, and teaching to the first person with respect to the at least one issue.

10. The method of claim 8, wherein the method further comprises:
after said instructing, providing by the second person at least one of psychotherapy and counseling to the first person with respect to the at least one issue.

11. The method of claim 8, wherein the method further comprises:
after said instructing, executing the activity by the second person concurrent with execution of the activity by the first person in response by the first person to said instructing.

12. The method of claim 11, wherein said concurrent executing by the second person comprises performing the at least one physical exercise by the second person at a same physical tension level as is performed by the first person during said execution of the activity by the first person.

13. The method of claim 1 1, wherein said concurrent executing by the second person comprises performing the at least one physical exercise by the second person at a different physical tension level than is performed by the first person during said execution of the activity by the first person.

14. The method of claim 8, wherein said instructing comprises executing the activity by the second person to demonstrate to the first person how to execute the activity.

15. The method of claim 1, wherein the method further comprises:
after said instructing, directing the first person to subsequently execute the activity according to a specified temporal regimen over a period of time comprising a plurality of days, said directing performed by the second person.

16. The method of claim 15, wherein the period of time is a specified fixed period of time.

17. The method of claim 15, wherein the period of time is a variable period of time that ends upon satisfaction of a specified condition.

18. The method of claim 1, wherein said instructing comprises instructing the first person to recite the words with strong emotion at about a highest volume level that the first person is capable of, or both with said strong emotion and at about said highest volume level.

19. The method of claim 1, wherein said instructing comprises instructing the first person to execute the activity in a gymnasium.

20. The method of claim 1, wherein the at least one physical exercise comprises an isotonic exercise.

21. The method of claim 20, wherein the isotonic exercise is a weight-bearing exercise.

22. The method of claim 1, wherein the at least one physical exercise comprises an isometric exercise, an aerobic exercise, or a stretching exercise.

23. The method of claim 1, wherein the method comprises instructing a plurality of persons to execute the activity, wherein the plurality of persons comprises the first person, wherein the words relate to at least one goal of each person of the plurality of persons, wherein the at least one goal of each person is unrelated to and not a consequence of the at least one physical exercise, and wherein said instructing is performed by the second person.

24. The method of claim 23, wherein the plurality of persons consists of a family, wherein the family consists of the first person and at least one family member of the first person, and wherein the at least one goal of each person comprises a same goal.

25. The method of claim 24, wherein each person of the family is at least one of a client, patient, and student of the second person with respect to at least one same issue that each person of the family has been attempting to resolve with assistance from the second person acting as at least one of a therapist, coach, and teacher of each person of the family.

26. The method of claim 25, wherein the family comprises spouses married to each other, and wherein one of said spouses is the first person.

27. The method of claim 25, wherein the family comprises a parent and a child of the parent, and wherein either the parent or the child is the first person.

28. The method of claim 23, wherein the plurality of persons consists of an audience of persons, and wherein said instructing is performed to said audience of persons by the second person functioning as at least one of a teacher and a coach of said audience of persons.

29. A method, comprising receiving, by a first person from a second person, instruction to execute an activity, wherein executing the activity comprises performing at least one physical exercise and reciting words during said performing the at least one physical exercise, wherein the recited words relate to at least one goal of the first person, and wherein the at least one goal is unrelated to and not a consequence of the at least one physical exercise.

30. The method of claim 29, wherein said reciting the words comprises repetitively reciting the words when performing the at least one physical exercise.

31. The method of claim 30, wherein the at least one physical exercise comprises a rhythmic pattern, and wherein said repetitively reciting the words comprises repetitively reciting the words synchronously with respect to the rhythmic pattern when performing the at least one physical exercise.

32. The method of claim 31, wherein the rhythmic pattern comprises a plurality of cycles of physical activity within a first physical exercise of at least one physical exercise, wherein each cycle comprises a plurality of phases, wherein said words comprise a plurality of verbal segments, and wherein said repetitively reciting the words comprises repetitively reciting each verbal segment of the plurality of verbal segments during a different phase of the plurality of phases in each cycle of the plurality of cycles.

33. The method of claim 29, wherein the at least one physical exercise comprises a plurality of physical exercises.

34. The method of claim 29, wherein the at least one goal comprises a plurality of goals.

35. The method of claim 34, wherein the at least one physical exercise comprises a plurality of physical exercises, and wherein said executing comprises reciting the words pertaining to each goal of the plurality of goals when performing a corresponding different physical exercise of the plurality of physical exercises.

36. The method of claim 29, wherein the first person is at least one of a client, patient, and student of the second person with respect to at least one issue that the first person has been attempting to resolve with assistance from the second person acting as at least one of a therapist, coach, and teacher of the first person.

37. The method of claim 36, wherein the method further comprises:
at least one of prior to and after said receiving said instruction, receiving by the first person from the second person at least one of psychotherapy, counseling, coaching, personal training, and teaching with respect to the at least one issue.

38. The method of claim 29, wherein the method further comprises executing the activity by the first person in response to said received instruction.

39. The method of claim 38, wherein said executing the activity by the first person in response to said received instruction comprises concurrently executing the activity along with execution of the activity by the second person.

40. The method of claim 39, wherein said concurrently executing comprises performing the at least one physical exercise by the first person at a same physical tension level as is performed by the second person during said execution of the activity by the second person.

41. The method of claim 39, wherein said concurrently executing comprises performing the at least one physical exercise by the first person at a different physical tension level than is performed by the second person during said execution of the activity by the second person.

42. The method of claim 29, wherein said receiving said instruction comprises observing the second person executing the activity to learn how to execute the activity.

43. The method of claim 29, wherein the method further comprises:
after receiving said instruction, receiving by the first person direction from the second person to subsequently execute the activity according to a specified temporal regimen over a period of time comprising a plurality of days.

44. The method of claim 43, wherein the period of time is a specified fixed period of time.

45. The method of claim 43, wherein the period of time is a variable period of time that ends upon satisfaction of a specified condition.

46. The method of claim 43, wherein the method further comprises executing the activity by the first person according to the specified temporal regimen in response to said received direction.

47. The method of claim 29, wherein said receiving said instruction comprises receiving said instruction to recite the words with strong emotion at about a highest volume level that the first person is capable of, or both with said strong emotion and at about said highest volume level.

48. The method of claim 29, wherein the at least one physical exercise comprises at least one of an isotonic exercise, an isometric exercise, an aerobic exercise, and a stretching exercise.
